(19) United States
(12) Patent Application Publication
(10) Pub. No.: US 2011/0000342 A1
(43) Pub. Date: Jan. 6, 2011

(54) WRENCH

(75) Inventors: J. EWING LAMBERT, INDIANOLA, IA (US); WAYNE K. HUISMAN, ORANGE CITY, IA (US)

Correspondence Address: MCKEE, VOORHEES & SEASE, P.L.C., 801 GRAND AVENUE, SUITE 3200, DES MOINES, IA, 50309-2721, US

(73) Assignee: TR TOOLS, L.L.C., ORANGE CITY, IA (US)

(21) Appl. No.: 12/827,073

(22) Filed: Jun. 30, 2010

Related U.S. Application Data
(60) Provisional application No. 61/222,549, filed on Jul. 2, 2009.

(51) Int. Cl. B25B 17/00

(52) U.S. Cl. 81/57

(57) ABSTRACT

An improved wrench includes a housing with opposite first and second ends and a pair of gears rotatably mounted in the first and second ends respectively. Each gear has a cylindrical sidewall with opposite ends and a plurality of teeth forming a sprocket extending radially outwardly from the sidewall between the opposite ends. A chain is trained about the gears within the housing. Upper and lower bushings are mounted in each end of the housing adjacent the sidewall of the respective gears to prevent contact between the gear sidewall and the housing.

### CROSS-REFERENCE TO RELATED APPLICATIONS

This application claims priority under 35 U.S.C. §119 of a provisional application Ser. No. 61/222,549 filed Jul. 2, 2009, and, which application is hereby incorporated by reference in its entirety.

### FIELD OF THE INVENTION

The present invention is directed towards a wrench having a slim profile for tightening and loosening nuts and fasteners in tight spaces or otherwise having limited access.

### BACKGROUND OF THE INVENTION

Wrenches of various sizes and shapes are commonly used for tightening and loosening nuts and bolts. One common type of wrench is a socket wrench including a socket rotated in clockwise and counterclockwise directions by a drive lever or arm. The socket typically includes a square hole on one end to matingly receive the square male drive shaft of the wrench, and a hexagon or multifaceted opening on the other end for receipt of the nut or bolt head.

Specialty flat or slim profile wrenches are also known for reaching nuts and bolts in tight spaces. Both gear drive and chain drive flat wrenches are known from the prior art. The gear drive wrenches include a plurality of intermeshing gears, which increases the manufacturing cost due to the number of pieces in the wrench. Chain drive flat wrenches generally are light weight and do not allow substantial torque to be applied to the nut or bolt head. These conventional wrenches often include a ratcheting mechanism to speed the process. However, with or without the ratchet action, the wrench must rotate about the nut to turn the nut. Thus, the wrench handle requires space to allow movement along a turning arc.

Therefore, a primary objective of the present invention is the provision of an improved slim profile wrench for reaching nuts and bolts in tight spaces.

Another objective of the present invention is the provision of a flat wrench having snap-in wear bushings on the sprockets at each end of the wrench.

A further objective of the present invention is the provision of a wrench with a first rotatable end which can be driven remotely from the opposite end.

Yet another objective is the provision of a wrench which can be used to tighten and loosen various types of rotational fasteners, including nuts and bolts, and screws having various heads.

A further objective of the present invention is the provision of an improved wrench which can remain in one position during use, without the need for a turning arc space for the wrench handle.

Another objective of the present invention is the provision of a flat wrench having a heavy duty chain drive.

Another objective of the present invention is the provision of a tight reach wrench having one piece with opposite female ends.

Yet another objective of the present invention is the provision of a wrench having gears at each end with bushings engaging the sidewalls of the gears to preclude contact between the gear and the wrench housing.

Still another objective of the present invention is the provision of a wrench having gears which are flush with the exterior wrench housing.

Another objective of the present invention is the provision of a slim profile wrench which can be coupled with other similar wrenches in an end-to-end series through male to male couplers.

Another objective of the present invention is the provision of a flat wrench having an internal channel or track for guiding the drive chain.

Still another objective of the present invention is the provision of a flat wrench having flush sockets and drives.

Another objective of the present invention is the provision of a flat, slim profile wrench for use in tight spaces which is economical to manufacture, and durable in use.

These and other objectives will become apparent from the following description of the invention.

### SUMMARY OF THE INVENTION

A slim profile wrench is provided for reaching nuts and bolts in tight spaces. The wrench includes first and second rigid casing members secured together to form a housing and having opposite ends. An internal wall in at least one casing member defines longitudinally extending channels or tracks for a drive chain. The casing members are secured together by fasteners extending into the central channel wall. Rotatable sprocket gears are provided at each end of the wrench. Each sprocket has a female drive on each end or side of the wrench. Each end of each casing member includes a recess for snap-fit receival of a wear bushing residing on each end of each sprocket. The sprocket drives are flush with the exterior surface of the casing members so that the wrench has flat upper and lower surfaces. The drive chain extends around the sprockets and along the internal channel in the housing to transfer rotational drive from the gear at one end of the wrench to the gear at the other end. Thus, the wrench handle does not need to pivot about a nut during use, and no ratcheting mechanism is required. Multiple wrenches can be connected in an end-to-end series through the use of an adapter or coupler having opposite male ends.

### BRIEF DESCRIPTION OF THE DRAWINGS

FIG. 1 is a perspective view of the wrench of the present invention.

FIG. 2 is an exploded perspective view of the wrench of the present invention.

FIG. 3 is a partially exploded perspective view of the wrench in a partially assembled state.

FIG. 4 is a perspective view of one of the bushings of the wrench.

FIG. 5 is a plan view of the bushing.

FIG. 6 is a side elevation view of the bushing.

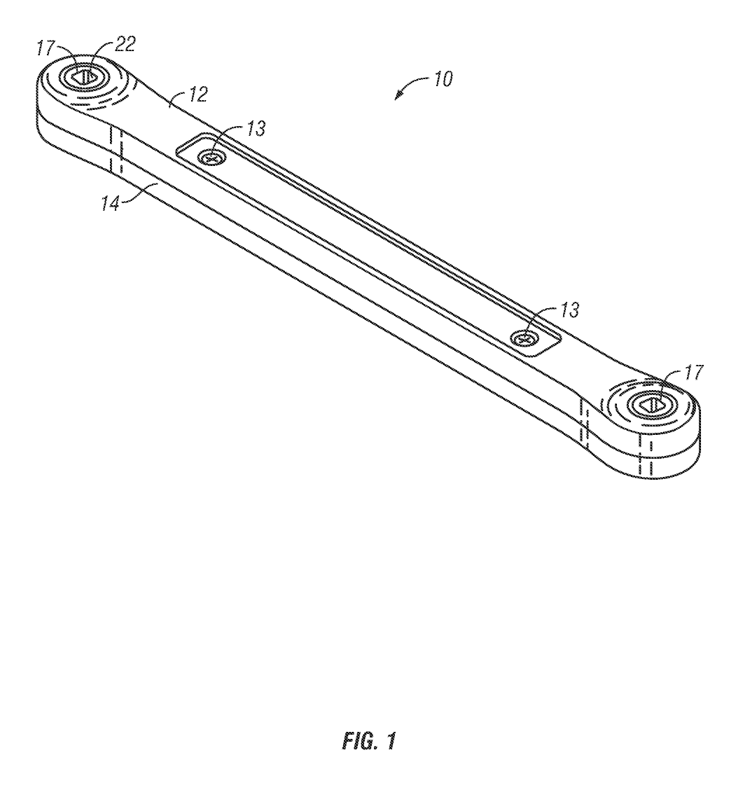

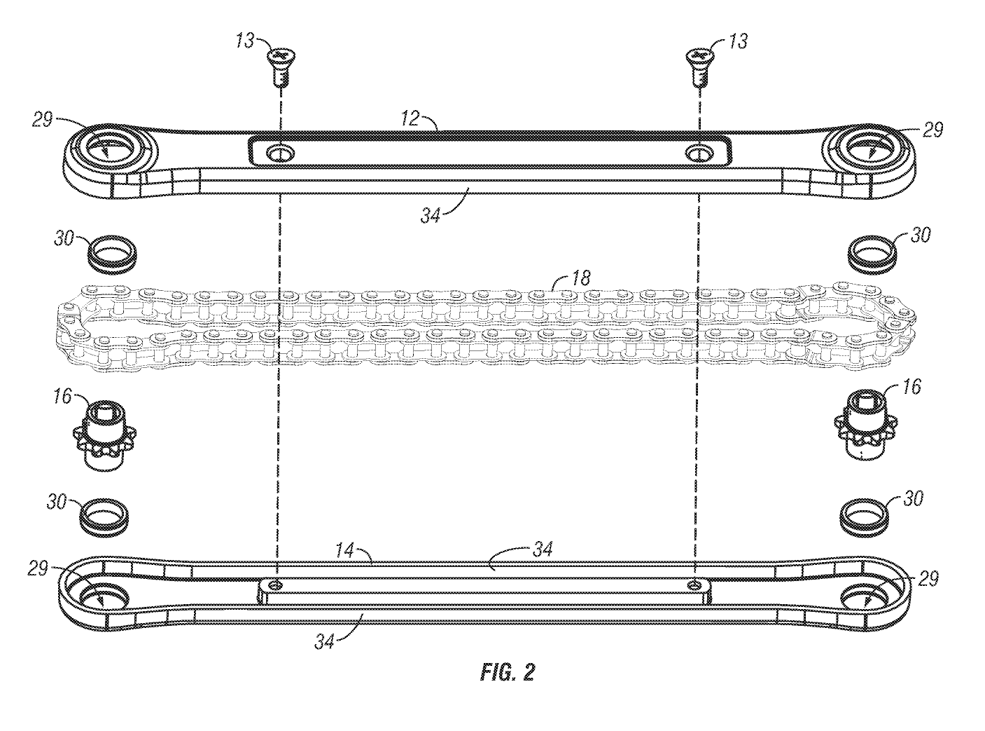

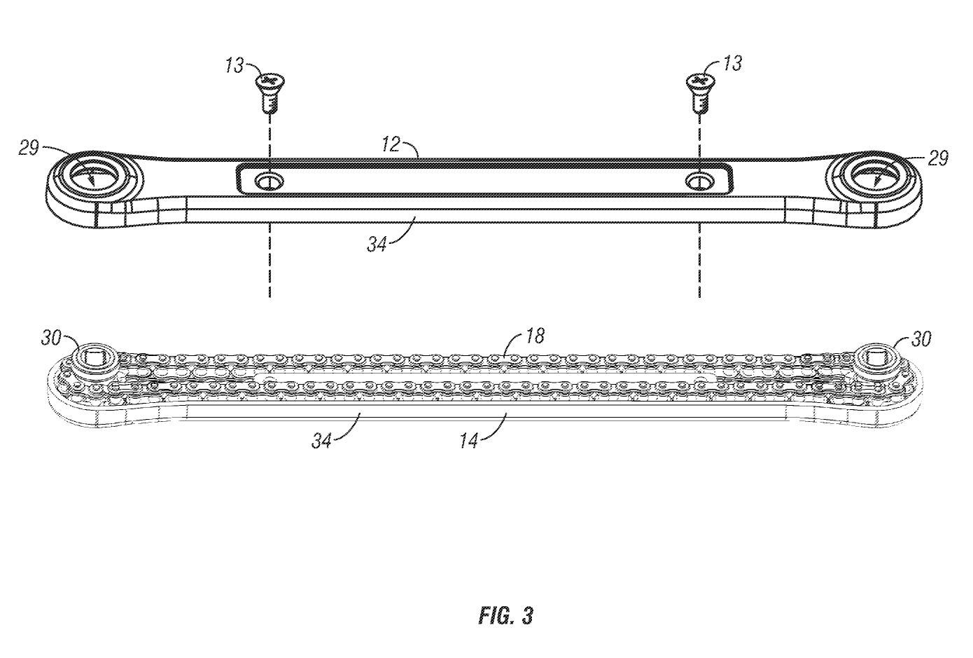

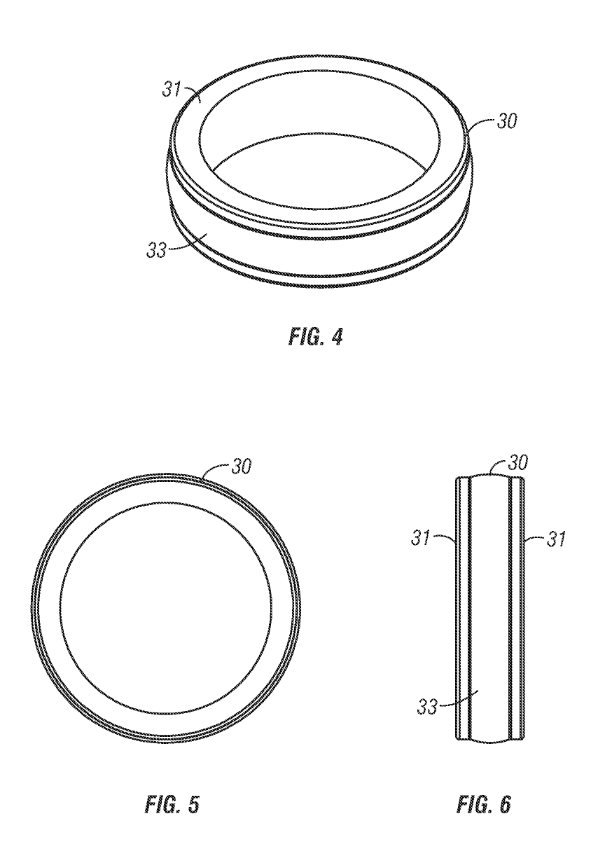

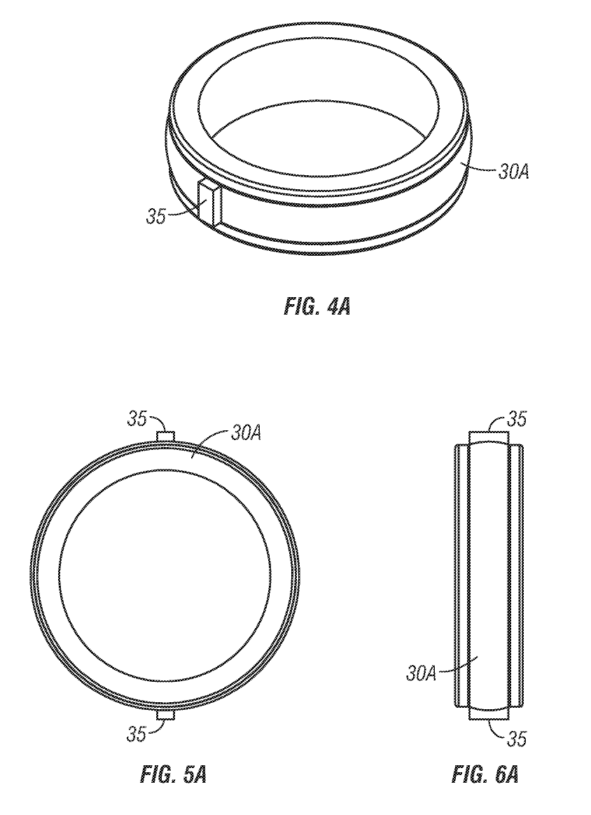

FIG. 4A is a perspective view of an alternative embodiment of the bushing.

FIG. 5A is a plan view of the alternative bushing.

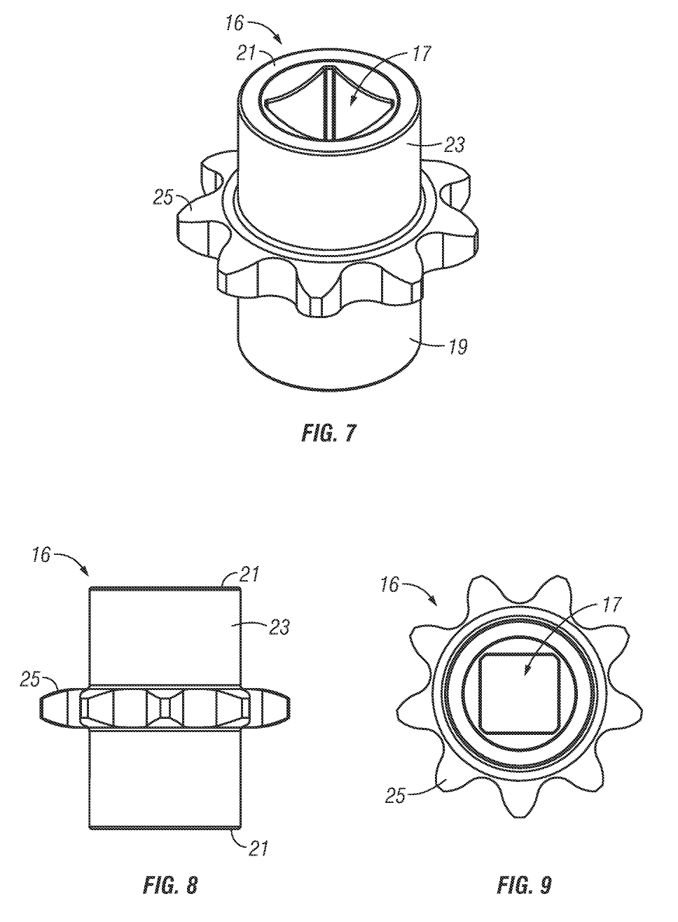

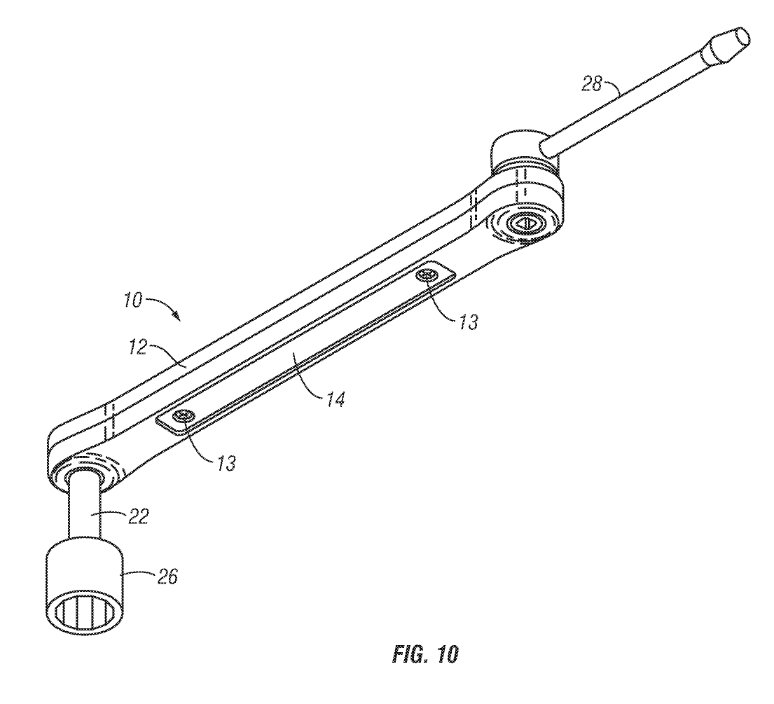

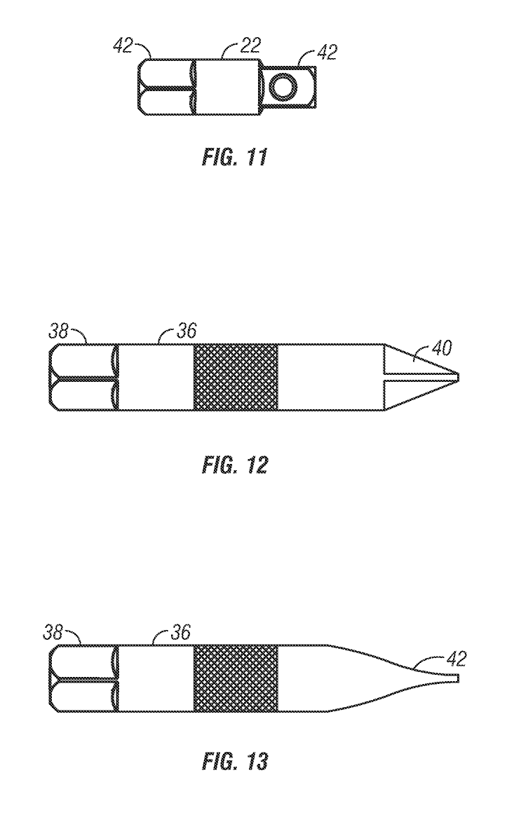

FIG. 6A is a side elevation view of the alternative bushing.

FIG. 7 is a perspective view of one embodiment of the sprocket gear of the wrench.

FIG. 8 is a side elevation view of the gear.

FIG. 9 is a plan view of the gear.

FIG. 10 is a perspective view showing the wrench used with a drive ratchet wrench.

FIG. 11 is a side elevation view of the male-to-male connector which mounts the drive wrench to the slim profile wrench of the present invention.

FIG. 12 is a side elevation view of an alternative extension having a Phillips tip for turning a Phillips head screw or fastener.

FIG. 13 is a side elevation view of another alternative extension with a flat blade tip for turning a screw having a slotted head.

### DETAILED DESCRIPTION OF THE INVENTION

The wrench 10 has a slim profile for use in tightening and loosening nut and/or bolts in tight spaces having minimal clearance. The upper and lower outer surfaces of the wrench are flat, for ease of insertion into a small space without interference.

The wrench includes first and second casing members 12, 14, which in a preferred embodiment, are identical to one another. The casing members are preferably cast metal. Each casing member 12, 14 includes a perimeter lip 34. The casing members 12, 14 include holes for receiving threaded fasteners 13. The holes on one of the casing members 12, 14 are threaded, while the holes on the other of the casing members 12, 14 are not threaded, such that the fasteners 13 extend through the unthreaded holes for threaded receipt in the threaded holes. When the casing members 12, 14 are assembled, the perimeter lips 34 engage one another so as to form a housing and enclose a chain 18.

Each casing member 12, 14 has an internal wall 20 extending longitudinally, so as to define channels or tracks on opposite sides of the wall 20. The channels provide a track for the chain 18, while the wall 20 precludes the chain 18 from rubbing against itself between the ends of the wrench. In an alternative embodiment, the wall can be formed on one casing member, while the other casing member has a flat inside surface to abut the wall when the members are assembled.

The wrench also includes gear sprockets 16 at the opposite ends, with the internal chain 18 trained about the sprockets to rotate the sprockets in clockwise and counterclockwise directions, as described below. Each sprocket 16 includes female drives 17 on each end. Preferably, the sprocket 16 is formed as a one piece unit for strength and ease of assembly of the wrench. Each sprocket 16 includes a cylindrical body 19 with opposite ends 21, and a sidewall 23 with a plurality of teeth 25 extending radially outwardly approximately mid-way between the opposite ends.

Each casing member 12, 14 includes a circular opening 29 through which the ends of the sprocket 16 extends. A wear bushing 30 is snap-fit into each casing opening 29 so as to preclude direct contact between the sprocket sidewall 23 and the casing member 12, 14. Preferably, the bushings 30 are snap-fit, press-fit, or friction-fit into the casing opening 29, so as to be fixed with respect to the opening 29, and without rotation in the opening 29. Such a snap-fit is achieved through mating surfaces on the bushing 30 and the casing member 29. As seen in FIGS. 6-8, the bushing 30 has opposite sides 31, with a central diameter 33 slightly greater than the diameter at each side 31 of the bushing 30. Thus, the bushing 30 includes a central perimeter portion with a slightly curved profile, which in a preferred embodiment, is matingly received in the casing member opening 29, which has a corresponding curved wall or recess. If the bushing 30 becomes worn, it can be easily pushed out of the casing member 12, 14 and replaced with a new bushing. The bushings provide a bearing surface at each drive end 21 of the sprocket 16, between the sprocket sidewall 23 and the edge of the hole 29, to rotatably support the sprocket 16 in the casing member 12, 14. Preferably, the bushing 30 is made of an ultra high molecular weight material.

In an alternative embodiment, a bushing 30A shown in FIGS. 6A-8A. The bushing 30A includes one or more tabs 35 to be received in a notch formed in the annular wall of the opening 29 of the casing member 12, 14, so as to assure that the bushing 30A will not rotate within the casing.

In use, one of the female drives 17 receives a coupler 22 with opposite male ends 24 and a socket 26 to be placed on the nut, and the second or outer female drive receives a drive shaft from another wrench 28 or drill so as to turn the socket 26 via the drive chain 18. The female drives 17 of each sprocket 16 preferably are in the form of a square hole to matingly receive a square drive shaft on the conventional socket wrench 28, as seen in FIG. 10. Thus, when the socket wrench 28 is actuated to rotate the female drive 17 at one end of the wrench, the socket 26 at the other end of the wrench is rotatably driven by the chain 18 so as to tighten or loosen the nut and bolt assembly. Thus, either end of the wrench 10 can be used as the drive end and the socket end.

As another option, an extension or adapter 36 with a square male end 38 can be inserted into one of the female drives, with the extension having a head adapted to tighten and loosen various fasteners, such as screws having a Phillips head 40, a straight slot head 42, a hex head, or a torx head. FIG. 12 shows an extension having a Phillips head 40, while FIG. 13 shows an extension having a head 42 for a slotted screw. As another alternative, the extension 36 may be magnetized so that the fastener is magnetically connected to the extension 36 when removed. Similarly, the sprockets 16 can be magnetized, with the magnetism automatically passing through the inserted socket 26 or extension 36 to retain a fastener after loosening and removal.

As an alternative, the female socket 17 of each sprocket 16 preferably has a hexagon opening or a multi faceted opening adapted to fit over the head of a bolt or onto a nut. A set of wrenches can be provided each having different sized female sockets, in English and/or metric versions. Thus, each wrench is an integral unit, and the set of wrenches eliminates the need to substitute different sized sockets in a single wrench.

Multiple wrenches 10 can also be used in an end-to-end series for an extended reach. For such an end-to-end series, then adapter 22 is provided which has a square male head 42 on each end for receipt in the female drive 17 of the respective wrenches. The adapter may lock the wrenches in a desired angular relationship. Adapters with different lengths may be provided.

The chain tracks and the integral, one piece construction of each sprocket 16, allows the wrench 10 to apply high torque. Also, pneumatic drives can be applied to the wrench 10.

The wrench 10 functions with a 0° turning arc. In other words, the wrench 10 does not require any lateral space to pivot, as in conventional wrenches. The housing of the wrench 10 remains stationary relative to the nut, and only the female drives 17 and chain 18 rotate.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A wrench, comprising:
first and second rigid casing members each having opposite ends with a hole in each end;
fasteners securing the first and second casing members together;
a channel formed in at least one of the casing members;
first and second gears rotatably mounted between the casing members at each of the ends;
each gear having opposite sides, with a female socket on each side;
a chain extending around the gears and along the channel so as to transfer rotational drive at one end to the sockets at the other end so as to tighten and loosen a fastener; and
bushings press fit in each hole to surround the sides of the sprockets and prevent contact between the gears and the casing members.

2. The wrench of claim 1 further comprising an adapter having opposite male ends to connect one of the gears to a separate socket.

3. The wrench of claim 2 wherein the separate socket is on a second wrench having the same casing members, channel, gears and chain components so that the wrenches are connected in series end-to-end.

4. The wrench of claim 1 wherein the casing members have a substantially flat profile along their full length and the female sockets reside within the casing members.

5. The wrench of claim 1 wherein the sockets are recessed in the casing members.

6. The wrench of claim 1 wherein each bushing is substantially cylindrical.

7. The wrench of claim 1 wherein each bushing is snap fit into one of the holes in the casing members.

8. The wrench of claim 1 wherein each gear has opposite ends which are flush with outer surfaces of the casing members.

9. The wrench of claim 1 wherein the gears are ratchet-free.

10. The wrench of claim 1 wherein the bushings are fixed in the holes against rotation.

11. The wrench of claim 1 wherein each bushing and hole have a mating tab and recess assembly to preclude rotation of the bushing in the hole.

12. A wrench, comprising:
a housing having first and second opposite ends;
a pair of gears rotatably mounted in the first and second opposite ends, respectively, and each gear having a cylindrical sidewall with opposite ends and a sprocket extending radially outwardly from the sidewall between the opposite ends;
a chain within the housing and being trained about the gears;
upper and lower bushings mounted in each end of the housing adjacent the sidewall of the respective gear to prevent contact between the gear sidewall and the housing.

13. The wrench of claim 12 wherein each bushing is frictionally retained in an opening of the housing so as to reside between the gear sidewall and the housing opening.

14. The wrench of claim 13 wherein each bushing is fixed against rotation relative to the housing.

15. The wrench of claim 12 wherein at least one end of each gear includes a female socket.

16. The wrench of claim 12 wherein each end of each gear includes a socket recessed with respect to the housing.

17. The wrench of claim 12 wherein the ends of the gears are substantially flush with the housing.

18. The wrench of claim 12 wherein each bushing is donut-shaped with inner and outer walls and top and bottom edges, and the outer wall being curved between the top and bottom edges.

19. The wrench of claim 12 wherein each bushing has a non-planar outer wall in cross section.

20. The wrench of claim 12 wherein each bushing is snap fit into an opening in the housing.
